(19) United States
(12) Patent Application Publication
(10) Pub. No.: US 2004/0153995 A1
(43) Pub. Date: Aug. 5, 2004

(54) Software development tool

(76) Inventor: Jean-Pierre Polonovski, Town Mount Royal (CA)

Correspondence Address: Bourque & Associates, P.A., Suite 301, 835 Hanover Street, Manchester, NH, 03104, US

(21) Appl. No.: 10/358,373

(22) Filed: Feb. 3, 2003

(51) Int. Cl. G06F 9/44

(52) U.S. Cl. 717/113; 717/105; 717/109

(57) ABSTRACT

A software development tool is disclosed. In one embodiment, a system includes an editor to assist in the development of source code for a computer program comprising a context analyzer and a grammar analyzer. The system also includes a completion module invoked without the need for any specific trigger event and operative to display a set of contextually valid identifiers and statements.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below: Copyright 2003, Madinina Software Inc., All Rights Reserved.

### TECHNICAL FIELD

This invention relates generally to software development environments, and more particularly to tools to assist in the completion of identifiers and statements.

### BACKGROUND INFORMATION

As it is known in the art, writing a program such as one written in a computer program language, often requires using complex notation and a program structure particular to the programming language being used. Programming languages include, for example, the C#, C, C++, Pascal, Visual BASIC, and Java programming languages. Typically, each particular programming language has its own syntax and structure.

Software programming languages have become more powerful over time through the addition of features and capabilities allowing developers to define procedures and data structures to meet their needs. However, the increased power and capability of modern programming languages has also added to their complexity. In addition, the programs developed using the programming languages have become larger and more complex, with one program typically comprising many different source code files.

One technique for program development includes using a programming language manual and performing data entry using a keyboard and terminal as with an editor. Such a technique often proves cumbersome and inefficient for program development, particularly for one who infrequently uses a programming language, or is just learning a programming language.

An alternative technique includes an interface to guide the user through the basic programming structure. One such mechanism includes using menus and forms, such as pull down menus with a graphical user interface. Typically, these menus and forms provide static definitions of language elements, such as programming statements. A static menu definition for a programming statement, as typically appearing on a menu or form, does not change throughout the program development. The static nature of menus and forms does not provide for a context sensitive representation of language elements with a large number of possibilities, as during program development when a user dynamically selects one particular language element. In other words, the static menus are unable to dynamically provide assistance in response to a current context, such as a particular statement being entered or selected by a programmer at a particular point in program development. Proper user assistance depends upon the nature of a problem and also the context in which the problem occurs.

Additional difficulties are typically encountered when on-line assistance is required, such as using a menu with on-line help documentation. In this case, the user generally must search through alphabetized lists for help on a particular language feature taking additional time and further decreasing efficiency.

The foregoing techniques do not provide for assistance which seeks to prevent errors rather than correct them once the statement or component thereof if fully keyed in. For example, a user typically inputs source code using either of the foregoing techniques producing a source file which is then compiled. The user is not provided with feedback as to syntax errors until the entire source file is entered and compiled. A lexical error generally occurs with an incorrectly formed language element, such as an invalid character in a programming language token (or “token”) representing a variable name, language keyword, or other input. As a result of lexical processing, user input is typically represented as tokens. A syntax error generally involves incorrect placement or omission of one token in relation to another token, such as a missing semicolon (“;”) in a programming language statement. Syntax errors may also be made in identifiers such as function names, variable names, class names, macro names and template names.

As a result, a market for compilers and interpreters—which are computer programs that turn source code of a program into an executable version that can actually be run on a computer—that make programming easier has proliferated. One manner by which compilers and interpreters have become somewhat easier to use is through the use of the Integrated Development Environment (IDE). These environments typically have browsers and editors allowing developers to edit multiple source files. In addition, for object oriented languages, the IDE may also provide a browser allowing the developer to navigate and view the class hierarchy.

While browsers are an improvement to compilers and interpreters, several problems remain. First, in order to look up the definition of a complex data structure, the user must locate the file containing the data structure definition, or must locate the class name in the class hierarchy browser.

Second, the user must locate the data structure definition in the file, which typically involves either scrolling through the file or using a text search capability to search through the file.

Third, once the definition has been located, the user must swap back and forth between the window containing the definition of the structure (either in a file window or a class hierarchy window) and the window in which the developer is currently adding code referencing the structure.

Finally, once the definition has been located, the user must manually insert the appropriate data structure reference into the code window.

Efficiency in developing programs typically decreases if a programmer is unfamiliar with a new programming language, or a particular area of a programming language. For example, when a new program is written in a different programming language unfamiliar to a computer programmer, the computer programmer has an additional task of learning the different programming language and its particular notation and structure.

Even if a programmer is familiar with a programming language, there are typically certain statements or forms of expressions which are infrequently used by a programmer. Thus, program development even for a knowledgeable programmer generally familiar with a programming language can be inefficient and cumbersome with regard to infrequently used features and statements.

Efficiency in program development also suffers once a new programming language is learned, and then infrequently used. The programmer does not typically retain knowledge of the programming language between infrequent program development sessions.

An automatic completion tool is described in U.S. Pat. No. 6,305,008 (Vaidyanathan et al.) which seeks to resolve some of theses problems, shortcomings and disadvantages. However, the completion module is invoked only upon the occurrence of an event. An event occurs when an identifiable first component is entered. If the user does not remember or know the proper syntax of the first component, the completion tool is of no use. In addition, this tool only offers identifier completion.

An example of an editor which may be used for the development of software programs is described in U.S. Pat. No. 6,016,467 (Newsted et al.). A trigger event is detected by monitoring user input. In response to detecting a trigger event, lexical and syntactical analysis is performed on the user input. Upon detection of an erroneous token in the user input, one or more valid language options are transmitted for use in place of the erroneous token. If no erroneous tokens are detected, one or more subsequent valid language options are transmitted. A trigger event is generally any pre-selected event in the computer system which causes invocation of the lexical and syntax analyzer. In this instance, a trigger event includes: the detection of a pre-selected trigger character in the user input, or selection of a button from a graphical user interface of the grammar sensitive editor directly requesting lexical and syntax analysis of the user input included in the edit buffer. Again, the editor is useless in those cases where the user does not remember or know the proper syntax of the trigger element.

Thus, there is required a new tool for program development and modification which provides for increased efficiency and accuracy in a convenient manner, is flexible and applicable in a wide variety of applications, and promotes productivity by assisting in construction of correct user input, and providing for exploration of alternative formats of user input especially in those case where the user does not remember or know the identity of all the tokens which may be used at the current cursor location or their proper syntax.

### SUMMARY OF THE INVENTION

The above-identified problems, shortcomings and disadvantages with the prior art, as well as other problems, shortcoming and disadvantages, are solved by the present invention, which will be understood by reading and studying the specification and the drawings.

In one embodiment, a system includes an editor and a completion module. The editor provides an environment for developing source code for a computer program, where the source code has statements, and the statements have expressions and entities. The expressions and entities in the statements can be made up of multiple components. Each component is sometimes described as a token.

The completion module is invoked at every keystroke or when specifically requested by the user.

The completion module then displays context-sensitive information allowing the developer to rapidly complete the token and the entire statement.

Thus, embodiments of the invention provide for advantages not found in previous systems. While a programmer is developing or writing source code for a program, in one embodiment the completion module is invoked at every cursor location as the programmer is writing the code. A list of potential completion candidates is presented to the developer, who can then pick the desired candidate or continue typing. The list of candidates is automatically supplied thereby freeing the developer from having to consult printed or on-line documentation, class hierarchies or other source code files. In this manner, development of computer programs is made easier and more productive as compared to previous systems.

The invention includes systems, methods, computers, and computer-readable media of varying scope. Besides the embodiments, advantages and aspects of the invention described here, the invention also includes other embodiments, advantages and aspects, as will become apparent by reading and studying the drawings and the following description.

### BRIEF DESCRIPTION OF THE DRAWINGS

FIG. 1 shows a diagram of the hardware and operating environment in conjunction with which embodiments of the invention may be practiced;

FIG. 2 shows a block diagram of a system according to one embodiment of the invention;

FIGS. 3(a), 3(b) and 3(c) show diagrams of representative screen shots of embodiments of the invention in which a statement drafting assistant provides context-sensitive data; and,

FIG. 4 shows a flowchart illustrating a method according to one embodiment of the invention.

### DETAILED DESCRIPTION OF THE PREFERRED EMBODIMENT

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

The detailed description is divided into four sections. In the first section, the hardware and the operating environment in conjunction with which embodiments of the invention may be practiced are described. In the second section, a system of one embodiment of the invention is presented. In the third section, a method, in accordance with an embodiment of the invention, is provided. Finally, in the fourth section, a conclusion of the detailed description is provided.

Hardware And Operating Environment

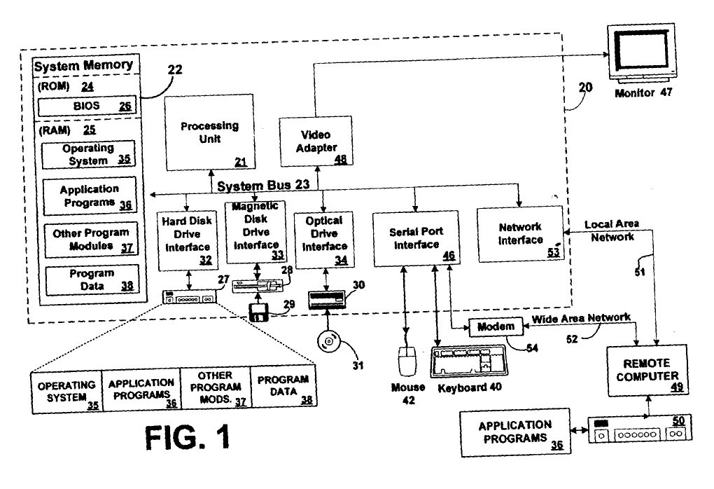

Referring to FIG. 1, a diagram of the hardware and operating environment in conjunction with which embodiments of the invention may be practiced is shown. The description of FIG. 1 is intended to provide a brief, general description of suitable computer hardware and a suitable computing environment in conjunction with which the invention may be implemented. Although not required, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The exemplary hardware and operating environment of FIG. 1 for implementing the invention includes a general purpose computing device in the form of a computer 20, including a processing unit 21, a system memory 22, and a system bus 23 that operatively couples various system components include the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with which embodiments of the invention may be practiced has been described. The computer in conjunction with which embodiments of the invention may be practiced may be a conventional computer, a distributed computer, or any other type of computer; the invention is not so limited. Such a computer typically includes one or more processing units as its processor, and a computer-readable medium such as a memory. The computer may also include a communications device such as a network adapter or a modem, so that it is able to communicatively couple other computers.

System

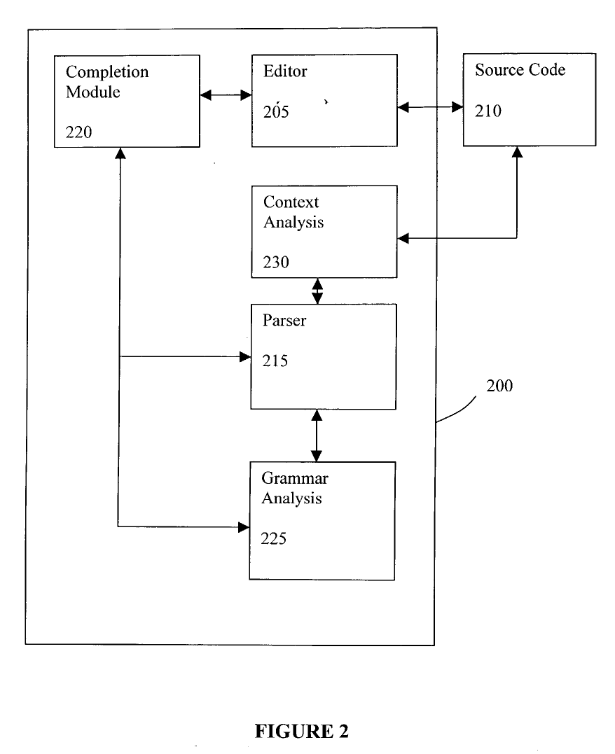

In this section of the detailed description, a description of a computerized system according to an embodiment of the invention is provided. The description is provided by reference to FIG. 2. Referring now to FIG. 2, a system according to an embodiment of the invention includes an IDE 200. As shown, the IDE 200 includes an editor 205, parser 215, completion module 220, grammar analysis module 225 and context analysis module 230. Those of ordinary skill within the art will appreciate that the IDE 200 also may include other components, not shown in FIG. 2; only those parts necessary to describe the invention in an enabling manner are provided. The parser 215 of IDE 200 may be capable of parsing any of one or more programming languages known in the art; the invention is not so limited. For example, the parser 215 can, in various embodiments, parse the following programming languages: C, C#, C++, Pascal, Visual BASIC, Java, etc., all of which are known in the art. In addition, IDE 200 may also include what is known in the art as an interpreter.

The source code 210 is a source code format of a computer program, as written in a given programming language by or for one or more computer programmers. Typically and as is known in the art, the source code comprises a series of statements which in turn are comprised of expressions. These statements are composed of various programming language tokens, which are combined to form declarations and definitions that describe the entities that make up the computer program. Identifiers are used to identify particular entities in the program, and include function names, variable names, class names, macro names and template names. Those of ordinary skill in the art will recognize that various entities and identifier mechanisms are used in various programming languages. The expressions in a statement can also typically be divided into multiple component parts.

The editor 205 of the IDE 200 provides for the developing (writing) of the source code 210 of a computer program.

The context analysis module 230 operates to determine where the cursor is located within the source code 210. More particularly, it determines where the cursor is located in relation to the end of the statement which immediately precedes it as well as the nature of such statement. From this information it suggests various possible scenarios. Examples of possible output of the context analysis module 230 are:

outside a namespace

within a namespace

within a definition type

within a type

within an attribute

within a member definition

within a property

within a function

The context analysis module 230 comprises two portions, a general context portion and a detailed context portion. The general context portion determines the general type while the detailed portion determines the exact element of such general type. For example, the general context portion may determine that the general context is a function while the detailed context portion may determine the function element is a function definition.

The parser 215 operates to parse the source code 210 according to the parsing rules applicable to the programming language. In a preferred embodiment of the invention, the parser used to implement method only needs to parse a subset of the source code, typically the from the end of the statement which immediately precedes the one being edited. This is highly desirable because parsing a complete file can take more time than a developer is willing to tolerate.

In an embodiment of the invention, several enhancements are added to the parser to support parsing only a portion of the code. First, the parser must be able to determine the location of the end of the statement which immediately precedes the one being edited.

Second, the parser is not required to identify each token or identifier in detail, indeed, only its type needs to be determined. Examples of types are statement tokens (if, for, while, . . . ), access tokens (public, privates . . . ), preprocessor tokens (#if, #region, . . . ), type definition tokens (class, interface, struct, enum, . . . ), type tokens (int, short, long, . . . ) and identifiers (function names, variable names, class names, macro names, template names, . . . ).

Third, because the code is incomplete (i.e. the developer is in the midst of writing the code) the parser must include heuristics to ignore certain non-fatal errors. Among these errors are missing statement terminators, missing closing parenthesis, missing function terminators and the like. In addition, the parser must be able to ignore errors resulting from unknown identifiers, unknown data types and unknown or missing function parameters. The parser must also be able to recover from what would otherwise be considered a fatal error and continue parsing the remaining code following the section causing the error

Fourth, it is highly preferable that the parser be able to parse subsets of code contained in memory buffers, rather than having to read the code from a file. This is desirable because it improves parsing speed by eliminating the need to save buffers to a disk file and provides feedback to the programmer while they are modifying their code.

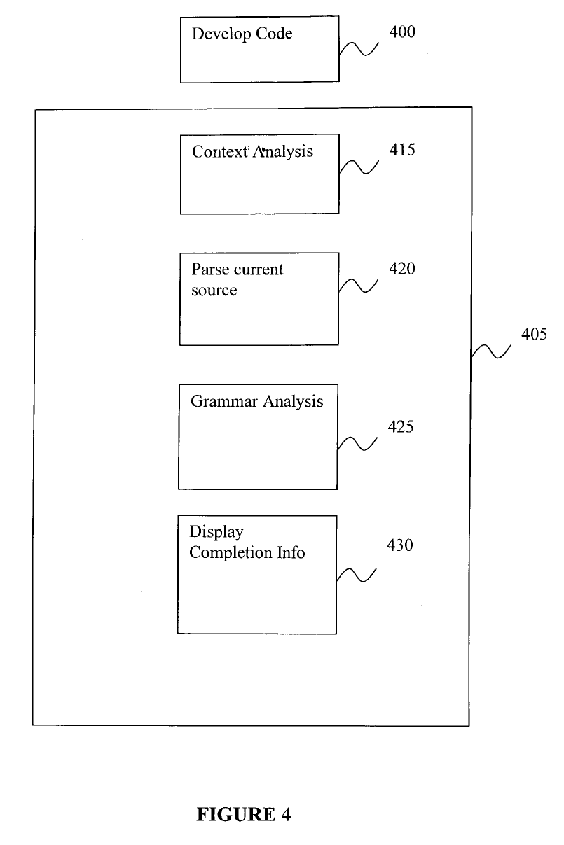

Completion module 220 is invoked by editor 205 at every cursor position rather than upon the occurrence of an event and employs the method described below with reference to FIG. 4 to suggest the use of certain expressions and statements as the developer is editing source code 210.

The grammar analysis module 225 determines the type(s) of language tokens or the identifiers which may be used at the current cursor position. Examples of possible language token types include, but are not limited to, access keywords (public, private, . . . ), preprocessor keywords (#if, #region, . . . ), type definition keywords (class, interface, struct, enum, . . . ), language predefined types (int, short, long, . . . or not), language statements (if, for, do, while, . . . ).

In one embodiment of the invention, the completion information presented to the user is dependent on the context provided by the current source code and the position of the cursor within the source code. For example, if the cursor is positioned in an area containing white space, the completion information presented to the user includes all language tokens that are potentially valid at that point in the code. This would include local variables, global variables, function identifiers, class identifiers and any other language token that is valid at that point in the source code. If the cursor is positioned near a class member reference, the completion information presented is narrowed to those identifiers that are attributes of the class, such as class member attribute identifiers and class function identifiers. If the cursor is positioned after a variable or class attribute identifier, the completion information presented includes operator tokens. In general, the information presented comprises those language tokens that are potentially valid at the point in the source code identified by the cursor position. When using the invention, there is no need to enter a full token. The grammar analyzer 225 and the context analyzer 230 are invoked as soon as a single character is entered. The context analyzer uses the characters that are currently being entered as well as information from the last previously entered statement to determine what is relevant at the current cursor position.

Thus, in accordance with one embodiment of the invention, the system of FIG. 2 operates as follows. A developer drafts the source code 210 within the editor 205. As the developer inputs a character, the context analyzer 230 determines the end of the immediately preceding valid statement. This position is then used as the starting point for the parser 215. In this way, it is not necessary to parse the entire source code file 210 every time a character is entered.

The grammar analysis module 225 is then invoked to determine the nature of the possible elements which may be validly used at the current cursor position. For example: an access language token, a preprocessor language token, a type definition language token, a type language token, a language statement token or an identifier.

A list of possible components which may be validly used at the current position is generated by the completion module 220. At this point it is possible to invoke existing completion tools such as IntelliSense (a trademark of Microsoft corporation), in those cases were the completion module 220 does not have any suggestion to make or if the current component type is determined to be an identifier.

Every time an additional character is entered, this process is repeated to further limit the possible choices. It is possible at anytime a suggestion is displayed by the completion module 220 to select it by clicking thereon or use keyboard keys such as the “up” and “down” keys. In a preferred embodiment, to choose the highlighted selection, the user simply enter a language separator character such as: (, [, ;, ., SPACE or CR. This results in the completion of the input in accordance with the chosen selection.

### EXAMPLE 1

Assuming the user inputs an “f” as a first character, the invention will propose various possible statements. For example:

[image]

Assuming the highlighted statement is selected, the cursor is positioned to replace the “@@” symbol and further suggestions will be made as shown hereunder:

[image]

If the highlighted selection is made, about 50 characters will have been generated by simply making 3 selections (three keyboard inputs).

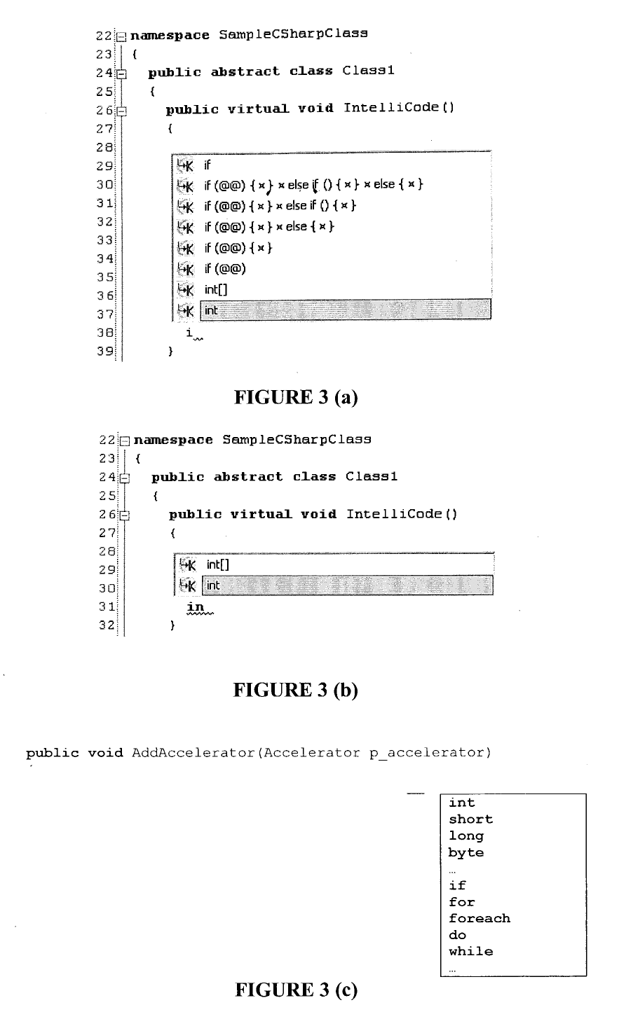

FIG. 3(a) illustrates a representative screen showing suggested statements if the single character “i” is entered in a given context. FIG. 3(b) illustrates how the possible selections become more focused as an additional character is entered. FIGS. 3(a), 3(b) and 3(c) are discussed in the context of the C# programming language, however the invention is not so limited. The invention is adaptable to any programming language.

Referring now to FIG. 3(a), a block diagram of a representative screen shot of an editor, according to one embodiment of the invention is presented. Several previously entered lines of code 304 are shown, along with a current line of code 306. As the developer is editing line 306, the developer enters a first character “i”. The editor invokes the completion module 220. Completion module invokes the method described below in reference to FIG. 4 and causes drop down box 308 to display a list of candidate expression components comprising class attributes of the class to which the object belongs. The developer may use the keyboard or a pointer device to highlight and select an attribute, which is then entered into the current line following the pointer operator.

FIG. 3(c) illustrates an embodiment in which possible selections are made even before a first character is entered.

It is desirable that program execution control not pass to the dialog box, thereby allowing the developer to continue adding characters to the statement. In this case the list of tokens in the drop down box is limited to those compatible with what the developer has entered or the dialog box is scrolled so that the nearest matching token is visible and highlighted. This token can be selected by a point and click operation or other means known in the art for selecting entities from a dialog or text box. In one embodiment of the invention, if, as the developer is typing, only a single matching candidate component exists, then the matching component is entered into the source code. In one embodiment of the invention, if the developer continues typing and enters a character that is not valid as an identifier name, the drop-down box disappears.

In a preferred embodiment, the user may customize the order in which the suggestions are presented to fit his/her code writing preferences. In yet another embodiment, the user may select that the invention suggest a single element of a statement rather than the entire statement.

Thus, in this manner, embodiments of the invention provide for advantages not found within the prior art. As the source code is written (developed), as in the prior art, by a computer programmer via the editor, the completion module is invoked without the need for an event to occur to provide context-sensitive candidate expression components for completing the statement or an element thereof.

Method

In this section of the detailed description, a method according to an embodiment of the invention is presented. The computerized method is desirably realized at least in part as one or more programs running on a computer—that is, as a program executed from a computer-readable medium such as a memory by a processor of a computer. The programs are desirably storable on a computer-readable medium such as a floppy disk or a CD-ROM, for distribution and installation and execution on another (suitably equipped) computer. Thus, in one embodiment, a computer program is executed by a processor of a computer from a medium therefrom to automatically complete programming language statements in source code as they are developed within an editor upon the occurrence of an event.

Referring now to FIG. 4, a flowchart of a method according to one embodiment of the invention is shown. In 400, at least a section of source code for a computer program is developed (written). Such source code may be written by a computer programmer utilizing an editor component in the IDE. In 405, an expression in the source code written in 400 is automatically suggested upon the entering of a first character. As seen in FIG. 3(c) it is also possible to invoke the invention by simply locating the cursor within the source code without entering any character. In one embodiment, the automatic completion is accomplished via 415, 420, 425, and 430.

The first step is to proceed to the context analysis 415. Then the method proceeds to parse the source code from the end of the statement immediately preceding the current cursor position The parser only parses the current function, if any, being edited. The parser returns information on tokens appearing at the current cursor position (if any), and identifying information regarding the token, such as its name, data type, and class membership. The information that the parser returns depends upon the expression before the cursor position or the token at the cursor position.

Next, at 425 the method uses the information provided by the parser at 420 to perform a grammar analysis. The data returned by the parser is used in the grammar analysis to return context-sensitive data. For example, if the parser indicates that the token at the current cursor position may be the beginning of a Class member definition, the grammar analysis will only seek rules for that particular case. If the cursor is over white space, the grammar analysis will not be as limited, and will return a larger set of data comprising the valid tokens that can be entered at that point in the code. When the cursor is located within the code defining a function, the set includes the function parameters, the class variables and local variables visible inside the function, i.e. the set of variables and other entities that are within the immediate scope for the function.

The method then proceeds to 430, which organizes and displays the information returned by the grammar analysis at 425. In addition, the information displayed may include other tokens valid at the current cursor position, such as programming language constructs comprising operators, separators, terminators, etc.

In one embodiment of the invention, the information is displayed in a drop down box. The developer can then pick an item from the drop down box, which is then inserted at the current cursor position in the source file. Those of ordinary skill in the art will recognize that alternatives to a drop down box are available, and within the scope of the invention.

As the developer enters new characters into the source code, the new information can be used to provide additional limitations. Typically, this will result in the elimination of those entries that are no longer valid or incompatible with what the developer added. In an alternative embodiment of the invention, the list is scrolled down to the nearest matching entry, which is highlighted.

A context-sensitive statement completion assistance tool has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is manifestly intended that this invention be limited only by the following claims and equivalents thereof.

What is claimed is:

1. A method comprising:
developing at least a section of source code for a computer program, said source code having language tokens (including statements and keywords) and identifiers;
determining the current position within the source code;
issuing a query to context and grammar analysis means containing context and grammar information, said query regarding at least one token or identifier of said plurality of tokens and identifiers; and
using the context and grammar information to display a set of potentially valid keywords, statements or identifiers relating to said at least one token of said plurality of tokens for potential prospective entry at said current position in the source code.

2. The method of claim 1, wherein developing the section of source code comprises utilizing an editor program.

3. The method of claim 1, wherein displaying the set of potentially valid tokens and identifiers displays the set in a drop-down box.

4. The method of claim 1, further comprising parsing at least a subset of the source code to obtain parser data, and wherein the query includes at least a subset of the parser data.

5. A system comprising:
an editor module to provide for developing source code for a computer program, said source code having a plurality of language tokens and identifiers;
context and grammar analysis means containing information about the language; and
a completion module invoked by the editor module every time the position of the cursor is changed within the source code and operative to query the context and grammar analysis means regarding at least one language token or identifier of said plurality of language tokens and identifiers and display a set of potentially valid language tokens or identifiers relating to said at least one language token or identifier for potential prospective entry at said current position in the source code.

6. The system of claim 5, further comprising a parser operative to parse at least a subset of the source code and to return parser data, and wherein the completion module uses the parser data to query the context and grammar means for information on the language tokens and/or identifiers and includes at least a subset of the language tokens and identifiers in the set of potentially valid language tokens and/or identifiers.

7. The system of claim 5, wherein the display of the set of potentially valid tokens and/or identifiers comprises displaying the set of potentially valid tokens and/or identifiers in a drop-down box.

8. A computer comprising:
a processor;
a computer readable medium;
cursor means;
an editor module to provide for developing source code for a computer program, said source code having a plurality of language tokens and a plurality of identifiers;
a context analysis module containing language token and identifier information;
a grammar analysis module containing language token and identifier information;
means to determine the current position of the cursor means within said source code;
a completion module invoked by the editor module when said cursor position is changed, operative to invoke said context analysis module and said grammar analysis module regarding at least one language token or identifier of said plurality of language tokens and identifiers and display a set of potentially valid language tokens and/or identifiers relating to said at least one language token or identifier for potential prospective entry at said current position in the source code.

9. The computer of claim 8, further comprising a parser operative to parse at least a subset of the source code and to return parser data, and wherein the completion module uses the parser data to query the context analysis module and the grammar analysis module for language token and identifier information and includes at least a subset of the language token and identifier information in the set of potentially valid entities.

10. The computer of claim 8, wherein the display of the set of potentially valid language tokens and/or identifiers comprises displaying the set of potentially valid entities in a drop-down box.

11. A computer-readable medium having computer-executable instructions for performing a method comprising:
developing at least a section of source code for a computer program, said source code having a plurality of language tokens and a plurality of identifiers;
determining the current position within said source code;
invoking a context analysis module and a grammar analysis module containing language token and identifier information upon detecting a change in the current position, said query regarding at least one language token or identifier of said plurality of language tokens and identifiers; and
using the language token and/or identifier information to display a set of potentially valid language tokens and/or identifiers relating to said at least one language token or identifier for potential prospective entry at a current position in the source code.

12. The computer-readable medium of claim 11, wherein developing the section of source code comprises utilizing an editor program.

13. The computer-readable medium of claim 11, wherein displaying the set of potentially valid language tokens and/or identifiers displays the set in a drop-down box.

14. The computer-readable medium of claim 11, further comprising parsing at least a subset of the source code to obtain parser data, and wherein the query includes at least a subset of the parser data.
